(19) United States
(12) Patent Application Publication
(10) Pub. No.: US 2025/0212294 A1
(43) Pub. Date: Jun. 26, 2025

(54) RADIO TRANSCEIVER DEVICES

(71) Applicant: Nordic Semiconductor ASA, Trondheim (NO)

(72) Inventor: Johan STRIDKVIST, Trondheim (NO)

(73) Assignee: Nordic Semiconductor ASA, Trondheim (NO)

(21) Appl. No.: 18/984,766

(22) Filed: Dec. 17, 2024

(30) Foreign Application Priority Data
Dec. 21, 2023 (GB) 2319841.9

(51) Int. Cl. H04W 76/34; H04B 1/40; H04W 28/18; H04W 76/10

(52) U.S. Cl. CPC H04W 76/34; H04B 1/40; H04W 28/18; H04W 76/10

(57) ABSTRACT

A first radio transceiver device is configured for communication with a second radio transceiver device. It sends the second device, over a first radio connection, a connection establishment data packet comprising connection timing information for establishing a second radio connection and establishes the second connection. Each connection is associated with a respective time series of periodic connection events for radio transmissions. After the second connection has been established, the first device suspends the first connection by ceasing transmitting any data packets to the second device over the first connection. While the first connection is suspended, the first device can transmit to the second device, or receive from the second device, over the second connection, a data packet comprising an activation request, and, thereafter, activate the first connection by transmitting a data packet to the second device over the first connection in a connection event associated with the first connection.

### CROSS REFERENCE TO RELATED APPLICATION

This application claims priority from Great Britain Application No. 2319841.9, filed Dec. 21, 2023, which application is incorporated herein by reference in its entirety.

### TECHNICAL FIELD

This disclosure relates to methods, devices and software for radio communication between radio transceiver devices.

### BACKGROUND

In Bluetooth™ Low Energy (BLE), a central device establishes a radio connection with a peripheral device. A radio connection has a periodic series of connection events which provide opportunities for radio packets to be sent between the central device and peripheral device.

There may be one or more independent radio connections established between a central device and a peripheral device. The different connections may each be used for transmitting different respective types of data between the two devices. The length of time between connection events may be different for different channel connections, and the data packets sent using each channel may have different scheduling priorities.

Maintaining more than one radio connection between a central device and a peripheral device can lead to increased power consumption by the transmitter and/or receiver of each device.

The present disclosure seeks to increase the efficiency of communication between wireless devices where more than one connection exists between two devices.

### SUMMARY

From a first aspect, the disclosure provides a first (e.g. central) radio transceiver device, configured for communication with a second (e.g. peripheral) radio transceiver device, wherein the first device is configured to:
send to the second device, over a first radio connection between the first device and the second device, a connection establishment data packet comprising connection timing information for establishing a second radio connection between the first device and the second device; and
establish the second radio connection between the first device and the second device using the connection timing information,
wherein the first radio connection is associated with a first time series of periodic connection events for radio transmissions between the first device and the second device, and the second radio connection is associated with a second time series of periodic connection events for radio transmissions between the first device and the second device; and
wherein the first device is further configured, after the second radio connection has been established:
to suspend the first radio connection by ceasing transmitting any data packets to the second device over the first radio connection;
when the first radio connection is suspended, to transmit to the second device, or to receive from the second device, over the second radio connection, a data packet comprising an activation request; and
after transmitting the activation request, or in response to receiving the activation request, to activate the first radio connection by transmitting a data packet to the second device over the first radio connection in a connection event associated with the first radio connection.

From a second aspect, the disclosure provides a second radio transceiver device, configured for communication with a first radio transceiver device, wherein the second device is configured to:
receive from the first device, over a first radio connection between the first device and the second device, a connection establishment data packet comprising connection timing information for establishing a second radio connection between the first device and the second device; and
establish the second radio connection between the first device and the second device using the connection timing information,
wherein the first radio connection is associated with a first time series of periodic connection events for radio transmissions between the first device and the second device, and the second radio connection is associated with a second time series of periodic connection events for radio transmissions between the first device and the second device; and
wherein the second device is further configured, after the second radio connection has been established:
to suspend the first radio connection by ceasing receiving any data packets from the first device over the first radio connection;
when the first radio connection is suspended, to receive from the first device, or to transmit to the first device, over the second radio connection, a data packet comprising an activation request; and
in response to receiving the activation request, or after transmitting the activation request, to activate the first radio connection by receiving a data packet from the first device in a connection event associated with the first radio connection.

From a third aspect, the disclosure provides a method of communication between a first radio transceiver device and a second radio transceiver device, the method comprising:
transmitting, by the first device, over a first radio connection between the first device and the second device, a connection establishment data packet comprising connection timing information for establishing a second radio connection between the first device and the second device;
receiving the connection establishment data packet at the second device; and
establishing the second radio connection between the first device and the second device using the connection timing information,
wherein the first radio connection is associated with a first time series of periodic connection events for radio transmissions between the first device and the second device, and the second radio connection is associated with a second time series of periodic connection events for radio transmissions between the first device and the second device; and
the method further comprising, after the second radio connection has been established:
suspending the first radio connection by:
   ceasing transmitting, by the first device, any data packets to the second device over the first radio connection; and
   ceasing receiving, by the second device, any data packets from the first device over the first radio connection;
when the first radio connection is suspended, transmitting, by the first device to the second device, or by the second device to the first device, over the second radio connection, a data packet comprising an activation request; and
after transmitting the activation indication or in response to receiving the activation indication, activating the first radio connection by transmitting, by the first device to the second device, a data packet in a connection event associated with the first radio connection.

From another aspect, the disclosure provides a radio communication system comprising a first radio transceiver device and a second radio transceiver device as disclosed herein.

From a further aspect, the disclosure provides software, optionally on a non-transitory computer-readable medium, which when executed on one or more processors of a radio transceiver device, cause the radio transceiver device to be (i.e. perform the disclosed actions of) a first radio transceiver device or a second radio transceiver device as disclosed herein.

Thus, it will be seen that, in accordance with at least some embodiments, communication over the first radio connection can be temporarily ceased between the first device and the second device after the second radio connection has been established. This may advantageously enable the first device and/or the second device to save power by not needing to transmit and/or receive data packets over the first radio connection. This can enable two radio connections to remain established between the first device and the second device without the need to periodically exchange radio packets between the first and the second device through both of the radio connections. Thus, use of the first radio connection can be limited to when the first radio connection is needed for transmitting and receiving data. As long as the second radio connection is established and active, it can be used to reactivate the first connection by transmitting the activation request over the second radio connection. Moreover, this activation may, in some embodiments, be performed within one or two connection events of the first time series, thereby enabling very low latency communication over the first radio connection.

At least in some embodiments, the first device and the second device can use the second time series of periodic connection events to maintain synchronisation with one another even when the first connection is suspended. Maintaining synchronisation may enable communication to be activated for the first radio connection efficiently by the first device transmitting the data packet over the first radio connection in a connection event of the first time series, i.e. even after a period of suspended communication over the first radio connection.

This differs from some conventional approaches for maintaining parallel independent radio connections between two devices in which a first radio connection is used to establish a second radio connection but must remain active thereafter, requiring periodic exchange of radio packets between the first and the second device through the first radio connection to be maintained.

In some embodiments the first device is configured to operate as a central device (e.g. a BLE central device). The second device may be configured to operate as a peripheral device (e.g. a BLE peripheral device). The first transceiver device may be configured to establish radio connections between the second device and one or more further radio transceiver devices, in addition to the second device. The same first device may be configured to operate both as a central device to one or more peripheral devices, and, at the same time or at a different time, as a peripheral device to one or more central devices. Each of the first device and the second device may be any electrical device, such as a wireless sensor, audio appliance, laptop computer, etc., or it may be a component for use within a larger appliance. In some embodiments one or both of the radio devices is an integrated circuit, such as a system-on-chip (SoC) or a radio-on-a-chip. Each radio device may comprise radio transceiver circuitry. Each radio device may include an antenna or may comprise an interface for connection to an external antenna. Each radio device may comprise interfaces for connection to other external components that may be required for the device to operate, such as a power supply, or a power amplifier, or a crystal oscillator, etc.

As set out above, each radio connection is associated with a respective time series of periodic connection events. The connection events for the first radio connection may be regularly spaced at a first connection interval, and the connection events for the second radio connection may be regularly spaced at a second connection interval, which may be different from the first connection interval. Each connection event may provide an opportunity for data transmission; however, transmission may be prevented for some connection events, e.g. by using a subrating mechanism where data is only received and/or transmitted once every k^{th} connection event, where k is a subrating factor that may be assigned to the second device for a respective radio connection with the first device.

One or more of the connection events for the first radio connection may start at a different time to the starts of the connection events for the second radio connection (i.e. starting at different instants), although where the respective connection intervals of the first radio connection and second radio connection differ, a subset of the connection events associated with the first radio connection may coincide with respective connection events associated with the second radio connection. Using different respective connection intervals and/or different respective starting times for connection events may help to reduce the number of occurrences of scheduling conflicts between radio transmissions over the different radio connections. The connection interval (i.e. its duration) and timing for connection events (e.g. an anchor point) for each of the radio connections may be communicated to the second device by the first device, and/or, in some embodiments, may be communicated to the first device from the second device.

For each radio connection, the first device and second device may be configured to exchange data using radio frequency hopping over a plurality of radio channels. The first radio connection may use a different frequency hopping sequence to the second radio connection. Data packets transmitted over the first radio connection may contain a different connection identifier from data packets transmitted over the second radio connection.

In some embodiments, the first device is a Bluetooth™ Low Energy (BLE) device and each of the first radio connection and second radio connection is a Bluetooth™ Low Energy (BLE) connection. The first and second devices may be devices of a BLE radio communication system. However, this is not essential in all embodiments, and the principles disclosed herein may also be advantageously applied to other proprietary or standardised radio protocols in some embodiments.

The first device may be configured to schedule data packets for transmission to the second device over the first radio connection and over the second radio connection. It may maintain a first queue for data packets for the first radio connection and a second queue for data packets for the second radio connection. The first radio connection may operate using a different scheduling priority to the second radio connection. The first device may be configured, at least under certain conditions, to prioritise the second radio connection over the first radio connection when a scheduling conflict arises (e.g. when two connection events overlap). This can ensure timely delivery over the second radio connection.

In some embodiments, the first radio connection is an asynchronous connection-oriented logical (ACL) transport. Where the first radio connection is a BLE connection, the first radio connection may be a low-energy asynchronous connection-oriented logical (LE ACL) transport. In some embodiments, the second radio connection is a Bluetooth™ LE Audio connection, such as a Bluetooth™ Connected Isochronous Stream (CIS). The second radio connection may be used for streaming audio data from the first device to the second device and/or vice versa. In other embodiments, the second radio connection may be a Bluetooth™ Channel Sounding connection for estimating the distance between two BLE devices. However, the principles disclosed herein may be applied to other proprietary or standardised radio protocols, within Bluetooth™ or not.

The first device and the second device may be arranged to use (i.e. receive and/or transmit over) the first radio connection for a first type of data, and to use (i.e. receive and/or transmit over) the second radio connection for a second type of data, wherein the second type of data is different to the first type. The second radio connection may be used for transmitting and/or receiving time-bound data (i.e. data that has a specific associated time constraint). The first radio connection may be used for transmitting and/or receiving non-time-bound data. The radio devices may be configured to control transmission of time-bound data using a flush time-out parameter which determines the length of time for which a data packet will attempt to be transmitted and/or decoded before being flushed. The scheduling of the transmission of time-bound data may prioritise low latency over throughput of data. For example, the second radio connection may be used for transmission and reception of streaming data (e.g. audio data, or continuous sensor data), whereas the first radio connection may be used for transmission and reception of data suitable for one-off or intermittent communication, such as command data and/or event signalling data. As such, the scheduling of the transmission of data over the first radio connection may prioritise data throughput over reduction of latency.

The timing information transmitted to the second device in the connection establishment data packet may comprise one or more connection parameters for the second radio connection, e.g. the connection interval length between each connection event in the second time series of periodic connection events. The connection establishment data packet may also comprise one or more configuration parameters other than timing information, e.g., information indicative of a frequency hopping sequence to be used for the second radio connection.

In some embodiments, the first radio connection is suspended in response to the second radio connection being established. It may be suspended immediately thereafter—i.e. the devices may cease transmission and/or reception of any data packets over the first radio connection from the next connection event of the first time series after transmission of the connection establishment data packet. Alternatively, communication may be suspended for the first radio connection a period of time after transmission of the connection establishment data packet. This period of time may be predetermined (e.g. by a configuration parameter stored on the first and/or second device), or it may be specified by data in the connection establishment data packet. Transmission of the connection establishment data packet may be considered to be complete once the full packet is detected by the receiving device, or once the receiving device finishes decoding the data packet, or once the receiving device finishes executing any action resulting from the decoding of the data packet.

Suspending the first radio connection may be considered equivalent to switching the first radio connection into a suspended state from an active state. When the first radio connection is in a suspended state, the first device may be configured not to schedule any data packets for transmission using the first radio connection. The second device may be configured not to transmit any data packets using the first radio connection.

The second device may be configured to support a low power state in which at least a portion of radio receiver circuitry of the second device is deactivated and/or a processor of the second device is in a sleep state. It may be configured to enter the low power state at times outside of connection events of the first and second time series. It may be further configured, when the first radio connection is suspended, to enter the low power state at times within connection events of the first time series that are not within connection events of the second time series.

When the second radio connection is operated independently of the first radio connection, and the connection intervals and events associated with the second radio connection are established independently of those associated with the first radio connection, one or more of the connection events of the first time series may, on occasion, coincide with a connection event of the second time series. Thus, radio transmissions between the first device and the second device through the second radio connection may coincidentally take place during a connection event of the first time series, even when the first radio connection is in a suspended state. However, it will be appreciated this is not the same as transmitting a data packet over the first radio connection.

Activating the first radio connection may be considered equivalent to switching the first radio connection out of the suspended state—i.e. switching the first radio connection into an active state. When the first radio connection is in an active state, the first and/or the second device may schedule data packets for transmission over the first radio connection—i.e. the first device and the second device may be configured to receive and/or transmit during at least a proportion of the first time series of connection events. For the first radio connection to remain in an active state, the first device may be required to periodically transmit data packets to the second device over the first radio connection and/or the second device may be required to periodically transmit data packets to the first device over the first radio connection.

The activation request may be transmitted from the first device to the second device, or the activation request may be transmitted from the second device to the first device. Some embodiments may support both of these options—i.e. either the first device or the second device may indicate that the first radio connection should be activated.

The circumstances under which the first device and/or the second device transmits the activation request may depend on the reason the first radio connection needs to be used. For example, where the first device needs to send a first type of data which the first device is configured only to send over the first radio connection, the first device may be configured to transmit the activation request to the second device before sending said data. Where the second device needs to send data to the first device over the first radio connection, the second device may be configured to transmit the activation request to the first device. The data packet comprising the activation request may further comprise other data intended for the receiving device, e.g. audio data.

The activation request may be provided anywhere within the data packet comprising the activation request, e.g. within a header or a payload of the data packet. The activation request may comprise a predetermined value. It may comprise a predetermined value at a predetermined position within the data packet—e.g., a predetermined binary value in a one-bit header field of the data packet. Thus, a data packet transmitted over the second radio connection (e.g. for sending audio data) can be efficiently used to transmit the activation request.

In some embodiments, communication through the first radio connection is activated at the next connection event of the first time series following the transmission and/or reception of the data packet comprising the activation request. This may advantageously provide minimal latency between indicating that the first radio connection should be activated, and then activating the first radio connection for data transmission. However, it is also envisaged that communication through the first radio connection may be activated at a later connection event following receipt of the activation request—i.e. at a connection event that does not immediately follow receipt of the data packet comprising the activation request. The data packet comprising the activation request may further comprise timing information which the receiving device may use to determine when to activate the first radio connection. For example, a time-delay with a value specified in milliseconds may be provided, or an integer number of connection events following the end of the receipt of the data packet comprising the request may be provided. Even when activation is not immediate, this can enable timely reactivation of the first radio connection, and may advantageously facilitate lower latency over the first radio connection, despite having been suspended, than if the first radio connection were kept active but with a significant subrating factor applied to it, which could result in a latency of many (e.g. hundreds of) connection events.

After communication over the first radio connection has been activated at a connection event following the receipt of the activation request by the receiving device, in some embodiments, the first radio connection is maintained in an active state for at least one or more further connection events of the first time series. In some embodiments, the number of further connection events may be predetermined, e.g. stored in the receiving and/or transmitting device. In other embodiments, the number of further connection events may be determined by data derived from the activation request—i.e. the data packet comprising an activation request may specify the number of connection events, or the length of time, for which the first radio connection should remain active before being switched back into a suspended state. Alternatively, the number of further connection events for which the first radio connection should remain active may be indefinite, and communication over the first radio connection may be suspended again in response to the transmission and/or reception of a data packet comprising a suspension request. Such a suspension request may be transmitted over the first radio connection and/or over the second radio connection.

Thus, in some embodiments, the first radio connection may be suspended after transmitting, or in response to receiving, a data packet comprising a suspension request. The first device may be configured, after the second radio connection has been established, to receive from the second device, or transmit to the second device, a data packet comprising a suspension request, and after transmitting or in response to receiving the suspension request, to suspend the first radio connection by ceasing transmitting any data packets to the second device over the first radio connection. The second device may be configured, after the second radio connection has been established, to receive from the first device or transmit to the first device, a data packet comprising a suspension request, and after transmitting or in response to receiving the suspension request, to suspend communication for the first radio connection by ceasing transmitting any data packets to the first device over the first radio connection. Such a suspension request may be transmitted over the second radio connection and/or the first radio connection.

In some embodiments the suspension request may be transmitted from the first device to the second device, or the suspension request may be transmitted from the second device to the first device—i.e. the first device or the second device may indicate that the first radio connection should be suspended. A suspension request may be provided within the last data packet of a sequential series of data packets sent from one device to the other over the first radio connection, after the first radio connection has been activated. The suspension request may be provided by indicating that no more data needs to be sent over the first radio connection. The suspension request may be provided anywhere within a data packet transmitted over the second radio connection (e.g. by including control information in a payload of a data packet), but in some embodiments, the suspension request is provided by setting or clearing a flag in the header of a data packet transmitted over the second radio connection, e.g. a one-bit flag. Thus, a data packet scheduled to be transmitted for sending payload data can be efficiently used to also transmit the suspension request. In some embodiments, a data packet comprising the suspension request may comprise a connection activation bit in a header of the data packet, and setting or clearing the connection activation bit provides the suspension request. The same connection activation bit in the header of a data packet transmitted over the second radio connection may be used to provide either an activation request, or a suspension request—e.g. a first binary value may indicate that the first radio connection should be suspended, and the opposite binary value may indicate that the first radio connection should be activated.

In some embodiments, the first and/or second device are configured to suspend the first radio connection in response to the second radio connection being established (e.g. shortly or immediately thereafter). However, in other embodiments, after the second radio connection has been established, the first radio connection may remain in an active state until a data packet comprising a suspension request is transmitted from the first device to the second device, or from the second device to the first device. In some embodiments, whether or not the first radio connection is suspended in response to the second radio connection being established may be determined by a multi-connection configuration parameter. This multi-connection configuration parameter may be predetermined and stored in one or both of the first device and/or the second device, or it may be exchanged during a wireless negotiation protocol between the first device and the second device, e.g. when establishing the first radio connection—e.g. during pairing of Bluetooth™ devices. This behaviour may depend on the type of devices, and/or the intended use of the devices.

Each of the first and second devices may comprise hardware circuitry configured to perform any one or more of the steps disclosed herein and/or may comprise one or more processors and memory storing software which, when executed by the one or more processors, cause the device to perform any one or more of the steps disclosed herein.

Features of any aspect or embodiment described herein may, wherever appropriate, be applied to any other aspect or embodiment described herein. Where reference is made to different embodiments or sets of embodiments, it should be understood that these are not necessarily distinct but may overlap.

### BRIEF DESCRIPTION OF THE DRAWINGS

Certain embodiments will now be described, by way of example only, with reference to the accompanying drawings, in which:

FIG. 1 is a schematic diagram of a radio system embodying the disclosure.

FIG. 2 is a schematic timing diagram showing how a Connected Isochronous Stream radio communication may be established between a central device and a peripheral device using a conventional method.

FIG. 3 is a schematic timing diagram showing how a Connected Isochronous Stream radio communication may be established between a central device and a peripheral device in accordance with methods embodying the disclosure.

FIG. 4 is a schematic diagram of fields within the header portion of a Bluetooth™ Low Energy Connected Isochronous Steam data packet.

FIG. 5 is a schematic diagram of fields within a header portion of a Bluetooth™ Low Energy Connected Isochronous Stream data packet transmitted in accordance with an embodiment of the disclosure.

### DETAILED DESCRIPTION

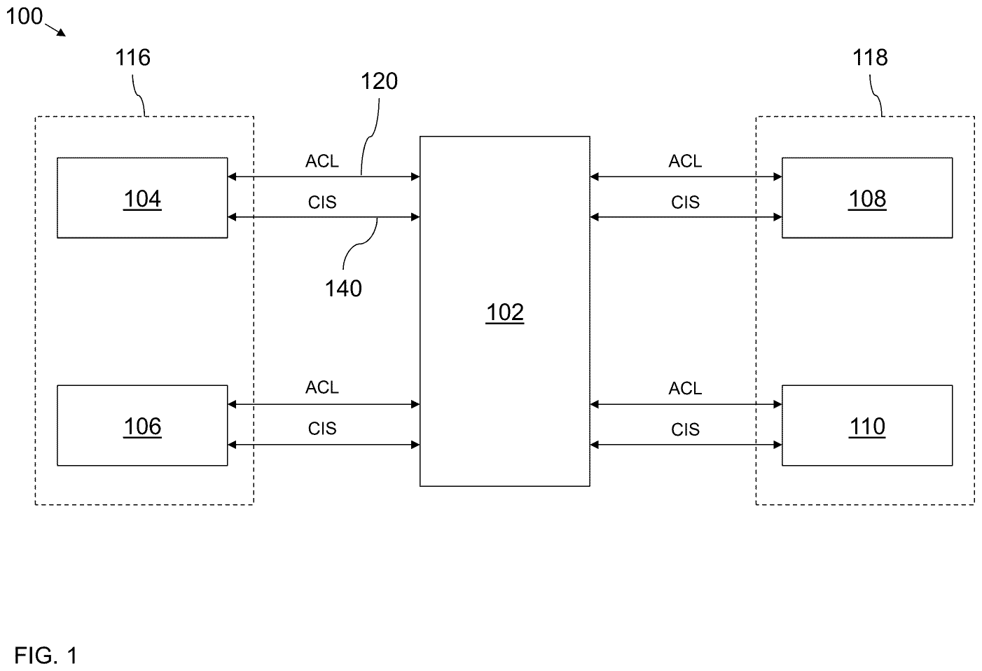

FIG. 1 is a schematic diagram of a radio system 100 comprising a central device 102, a first peripheral device 104, a second peripheral device 106, a third peripheral device 108 and a fourth peripheral device 110. Each of the peripheral devices 104-110 can exchange data with the central device 102 over respective radio connections. The radio transceiver devices 102-110 communicate using a shared radio protocol, which in some examples is Bluetooth™ Low Energy (BLE). Whilst it is envisaged that the methods described herein may be applicable to various radio protocols, the specific examples described below are described with respect to radio communication using BLE radio protocols.

Each device 102-110 may be a static or mobile electronic device such as a wireless sensor, a domestic appliance, a vehicle, a personal computer, a cellular telephone, wireless headphones, etc. Each device 102-110 may include a processor and memory storing software instructions for execution by the processor. Each may include a radio transceiver, e.g. provided as a radio-on-a-chip, with an antenna and other components for radio transmission and reception. Any of the operations disclosed herein may be implemented in hardware (e.g. by dedicated analog and/or digital circuitry) or in software, or in any appropriate combination of hardware and software.

In the radio system 100 shown in FIG. 1, two different types of BLE radio connection can be established by the central device 102 with each of the peripheral devices 104-110—namely, a low-energy asynchronous connection-oriented logical (ACL) transport connection, and a connected isochronous stream (CIS). For example, in the radio system shown in FIG. 1, a first radio connection 120 between the central device 102 and the first peripheral device 104 is an ACL radio connection while a second radio connection 140 between the central device 102 and the first peripheral device 104 is a CIS.

ACL is one of the most commonly used Bluetooth™ Low Energy (LE) logical transport type for communication of data.

A Connected Isochronous Stream (CIS) can be established between a central device and a peripheral device for transferring time-bound data. A CIS can be used for LE Bluetooth™ Audio connections, for example.

Time-bound data exchanged through a CIS has a time-limited validity period, at the end of which it is said to expire. Expired data which has not yet been transmitted is discarded. This means that devices only ever receive data which is valid with respect to rules regarding its age and acceptable latency. This is particularly suitable for audio data, where the timeliness and order in which audio packets are processed is important for the perceived quality of the eventual audio stream to a user. CIS is thus often used for the timely transfer of audio data, although it could be used for other types of data which are suited to being transferred in a time-bounded manner.

This time-bound communication is different to communication through an ACL connection. Communication through an ACL connection is queued in order of intended transmission. When transferring data from one device to another, an acknowledgment must be received before moving on to the transmission of the next data packet. By contrast, using a CIS, if a peripheral device 104-110 does not receive a data packet, the data will eventually be flushed. This protocol over a CIS connection is suitable for audio streaming, where the timing of the receipt of data packets is more important than receiving all of the data packets. Flush time-outs are configurable at an application level. Typically, it is acceptable to have significantly higher latency in communication over an ACL connection, than over an isochronous stream. The central device 102 may therefore typically schedule ACL packets with a lower scheduling priority compared with CIS packets.

Isochronous streams are often used in circumstances where data needs to be streamed to several peripheral devices, and the time at which each device processes the received data needs to be coordinated across peripheral devices. CIS streams can be members of groups called Connected Isochronous Groups (CIGs), each of which may contain one or more CISs. In the radio system 100 shown in FIG. 1, the first peripheral device 104 and the second peripheral device 106 form a first pair 116 (e.g. being left and right units of a stereo speaker pair), and their respective CIS's belong to a first CIG, whereas the third peripheral device 108 and fourth peripheral device 110 form a second pair 118 and their CIS's belong to a second CIG.

Devices having CIS's within the same CIG wait for a period of time to allow all streams of the group to have the opportunity to deliver related packets before the devices process packets received over their respective CIS's at the same time. For example, if the first CIG in FIG. 1 is used for delivering stereo music, the CIS 140 between the central device 102 and the first peripheral device 104 may be used for the left stereo channel audio data, and the CIS between the central device 102 and the second peripheral device 106 may be used for the right stereo channel audio data. The rendering (i.e. playback) of the audio streams received at the first peripheral device 102 and the second peripheral device 106 is synchronised such that it takes place at the same time in both devices, meaning that the user hears stereo music as intended. Communication over each of the ACL connections and the CIS connections occurs within a respective series of connection events. Connection events are time windows that provide opportunities for radio packets to be sent between the central device 102 and a peripheral device 104-110.

An ACL connection between a central device 102 and a peripheral device 104-110 is assigned a connection interval, which is the time between the starts (“anchor points”) of successive regular connection events. Each connection event provides an opportunity for the central device 102 to exchange data with a respective peripheral device 104-110. Specific connection events may also be referred to as connection instants. Multiple packets may be transferred to and from a peripheral device 104-110 during one connection event. Each connection event normally contains at least one packet sent by the central device 102. However, the central device 102 may fail to transmit in a connection event at all on occasions, e.g. due to scheduling conflicts or if a subrating factor is being used.

When an ACL connection is established between a central device 102 and a peripheral device 104-110, various parameters are set by the central device 102 to control the connection events between the two devices—i.e. to establish how regularly the two devices need to be in communication to keep the ACL connection alive.

After connection parameters have been agreed between the central device 102 and a peripheral device 104-110, and clock synchronisation is established between the two devices, the receiving circuitry of the peripheral device can choose to start to listen on a given frequency channel (determining in accordance with a frequency-hopping pattern) at a time shortly before a data packet is expected from the central device. Typically, the peripheral device 104-110 may reply to the central device 150 microseconds (+/−2 μs) after receiving the last bit of the packet from the central device 102. Typically, the central device and the peripheral device then take turns, alternating between transmitting and receiving packets and may exchange a number of packets during the connection event.

It can be beneficial, in some circumstances, to reduce the regularity with which a peripheral device 104-110 and the central device 102 are in communication. This may allow receiving circuitry in the peripheral to be powered down between connection events and therefore save power, only being activated for the predetermined connection events. It may also reduce power consumption by the central device 102 by reducing the number of data packets that must be transmitted simply to keep the connection alive. Parameters that can be used to control the connection events between a central device and peripheral device are set out in more detail below.

The “connection interval” parameter for an ACL connection defines how often the radio can be used for servicing the connection. Whenever the connection interval elapses, a new connection event begins and the central device 102 may transmit a packet. BLE connection intervals can range from 7.5 ms to 4 secs, in increments of 1.25 ms. A longer connection interval increases the time between connection events, i.e. it reduces how often the ACL connection can be used to transmit a data packet, thereby increasing latency but potentially reducing power consumption.

An equivalent parameter, “ISO interval”, is defined for each CIS connection, and can have a value from 5 ms to 4 secs.

The “supervision timeout” parameter for an ACL connection specifies the maximum time which may elapse between receiving two link layer data packets before the connection is considered to have been lost. A longer supervision timeout parameter therefore allows a longer time between the last received data packet and when the ACL connection is deemed to have been lost. Typically, the maximum acceptable supervision timeout is governed by the need for the clocks of the central and peripheral devices to maintain synchronisation. Synchronisation between the central and peripheral devices is needed so that each peripheral 104-110 can activate its radio receiver circuitry to listen for a data packet at the correct time for a given connection event.

The “peripheral latency” parameter for an ACL connection defines the number of consecutive connection events during which the peripheral device does not have to be listening for a packet transmitted by the central device. This allows the peripheral device to save power by potentially powering down its receiver circuitry in the unused connection events.

The “subrate factor” parameter for an ACL connection can define a ratio of used connection events to skipped connection events for communication between a central device and a peripheral device. Subrating can be used to allow an ACL connection to switch rapidly between a fast duty cycle, defined by the underlying connection interval for the connection, and a slower duty cycle, in which only a subset of the nominal connection events assigned to the connection are actually used by the peripheral device for exchanging data with the central device. The subrate factor, k, instructs the peripheral device to use only every k^{th} connection event. This may advantageously reduce the power consumption of the central device as well as the peripheral device.

Each CIS is established between the central device 102 and a respective peripheral device 104-110 using the respective ACL connection with the peripheral device. As described in more detail below, this involves the central device 102 sending the respective peripheral a CIS establishment data packet (“LL_CIS_IND”) comprising connection timing information for establishing the CIS between the central device and the peripheral device.

A CIS can have an ISO interval that is different from the connection interval of the ACL that was used to establish the CIS.

Where an ACL connection is used to establish a second, independent radio connection, such as a CIS, between a peripheral device and a central device, there are further opportunities for power-saving in the transceiver circuitry of the peripheral and central device, by using the novel principles disclosed herein. These mechanisms are exemplified in further detail below.

Whilst the examples described herein are with reference to ACL and CIS connections between peripheral devices and central devices, the same principles may equally apply to other types of radio connections which are established between two devices. For example, they may be applied to an ACL connection and a Bluetooth™ Channel Sounding (CS) connection.

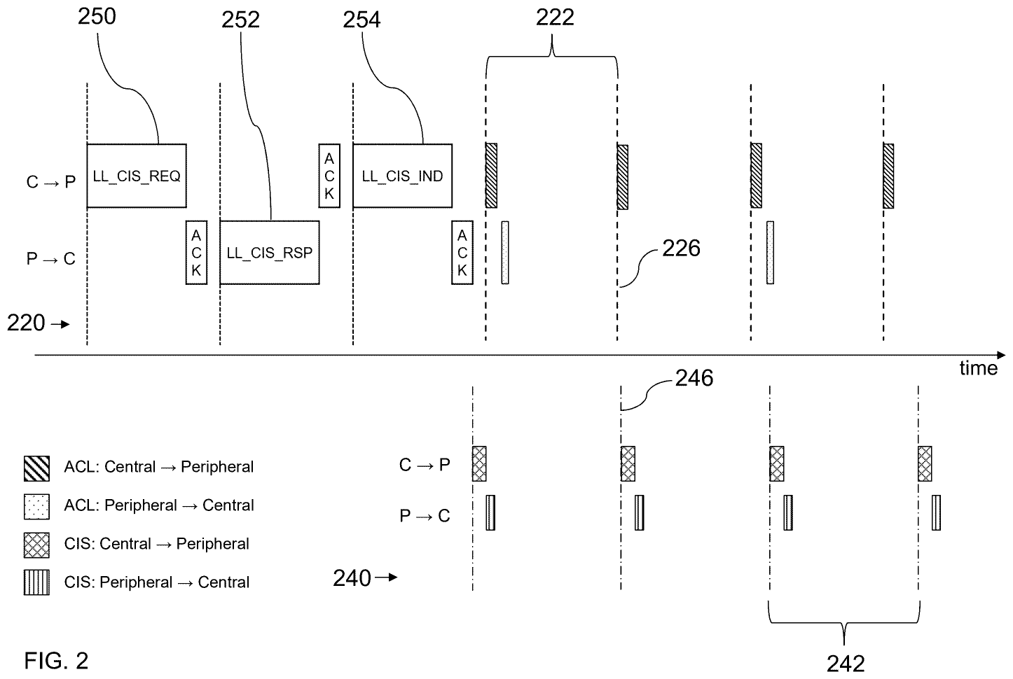

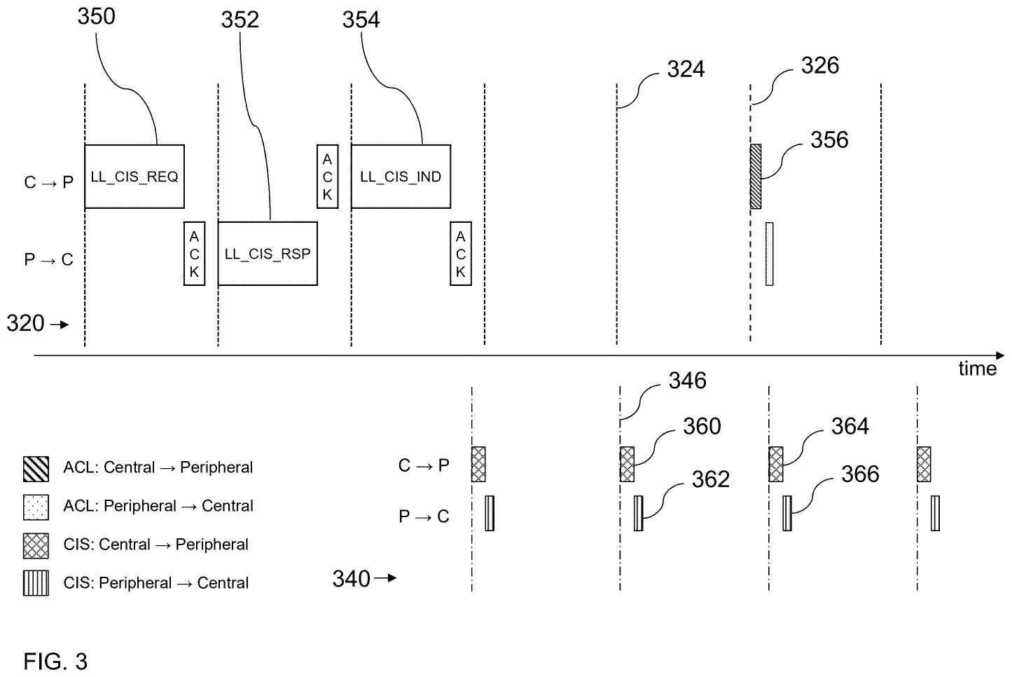

FIG. 2 is a schematic timing diagram showing how a CIS radio connection may be established between a central device and a peripheral device using conventional BLE mechanisms. The exemplary radio system 100 may support these conventional mechanisms, but also supports a novel mechanism described in more detail below with reference to FIG. 3.

FIG. 2 shows, along a time axis, two-way communication between a central device and a peripheral device over an ACL connection 220 and a CIS connection 240. The ACL connection 220 comprises a time series of periodic ACL connection events, spaced at regular connection intervals 222, for radio transmissions between the central device and the peripheral device. The CIS connection 240 comprises a time series of periodic CIS connection events for radio transmissions between the central device and the peripheral device, spaced at regular ISO intervals 242. For the connections shown in FIG. 2, the ACL connection intervals (e.g. 222) have a different duration to the CIS connection intervals (e.g. 242).

In accordance with conventional operation of a Bluetooth™ Low Energy isochronous stream, establishing a CIS connection 240 first requires an ACL connection 220 to be created. This ACL connection 220 serves two purposes. Firstly, it allows link layer control protocol data units (PDUs) to be exchanged between the central device and the peripheral device. Secondly it provides a timing reference point against which to schedule CIS events 244 once the CIS connection 240 has been established. In order to establish the CIS connection 240, the central device initiates the procedure over the ACL connection 220 by sending a CIS request packet 250 comprising an LL_CIS_REQ PDU, as shown in FIG. 2. The peripheral device replies with a response packet 252 comprising an LL_CIS_RSP PDU. The CIS connection 240 is established when the central device then sends a CIS establishment packet 254 comprising an LL_CIS_IND PDU. The LL_CIS_IND PDU contains parameters which determine the timing of the connection events in the CIS connection 240 and a delay to apply before synchronously rendering the data exchanged over the CIS connection at the specific peripheral device.

After the CIS connection 240 has been created, the CIS connection 240 operates independently of and alongside the ACL connection 220 which was used to create it—i.e. the ACL connection intervals 222 and the CIS connection intervals 242 can have different lengths, and packets are queued separately for exchange over each connection, with different frequency channel hopping sequences used for each connection 220, 240.

FIG. 2 shows an ACL connection 220 with a peripheral latency of two and no subrating, i.e. the central device transmits an ACL data packet at every ACL connection event 224 and the peripheral device responds with an ACL packet in every other ACL connection interval. After the CIS connection 240 shown in FIG. 2 is established, the central device transmits a CIS data packet every CIS connection event (e.g. 246), and the peripheral device responds with a CIS response data packet (e.g. 262) during every CIS connection interval (e.g. 242). As a result of the two connections being timed independently of one another, on occasion, an ACL connection event may coincide with a CIS connection event. For example, as shown in FIG. 2, a start (anchor point) 226 of one of the ACL connection events coincides with a start (anchor point) 246 of one of the CIS connection events. Although the radio connections are independent, they share the same transceiver circuitry in each of the central device and peripheral device so cannot be transmitting simultaneously. Therefore, in this instance shown in FIG. 2, due to the higher scheduling priority of the CIS connection, the ACL data packet will be delayed or dropped by the scheduler of the central device 102. In some circumstances, clashing transmissions between the two radio connections may instead result in the loss of CIS data packets.

In accordance with conventional Bluetooth™ Low-Energy implementations at the time of writing, if the ACL connection 220 is closed, the associated CIS connection 240 is also terminated. Keeping the ACL connection 220 alive requires intermittent communication at a proportion of ACL connection events 224 which is governed by one or more of the parameters described in more detail above (e.g. subrating and/or peripheral latency).

The present disclosure provides a novel mechanism by which the ACL connection 220 is no longer required to be used intermittently in order to keep it alive. Instead, once the isochronous stream connection 240 is created, the ACL connection 220 can be suspended indefinitely without being closed. An activation flag may subsequently be provided in a packet transmitted in the Connected Isochronous Stream to reactivate the ACL connection. The ACL connection will be reactivated for the next available connection event following the end of the CIS packet containing the activation flag.

This can reduce power consumption by reducing activity over the ACL connection 220. It may also have the effect of reducing the number of instances of clashing connection events between the two radio connections.

FIG. 3 is a schematic timing diagram showing how a CIS radio connection can be established and operated between a central device and a peripheral device in accordance with the principles disclosed herein. In a similar manner to FIG. 2, two-way communication between a central device 102 and a peripheral device 104-110 over an ACL connection 320 and a CIS connection 340 is shown, along a common time axis.

In order to establish the CIS connection 340, the central device initiates the procedure over the ACL connection 320 in a similar manner as described with reference to FIG. 2—i.e. by sending a CIS request packet 350 comprising an LL_CIS_REQ PDU. The peripheral device replies with a response packet 352 comprising an LL_CIS_RSP PDU and the CIS connection 340 is established when the central device then sends a connection establishment data packet 354 comprising an LL_CIS_IND PDU.

After the CIS connection 340 has been created, as before, the CIS connection 340 operates independently of the ACL connection 320 which was used to create it. However, in contrast with conventional approaches, in this embodiment communication over the ACL connection 320 can be suspended after the CIS connection 340 is established—i.e. such that the central device 102 ceases transmitting any ACL data packets to the peripheral device 104-110 over the ACL connection after the CIS connection 340 is established.

As can be seen in the example timing diagram of FIG. 3, after the CIS connection 340 is established, the central device 102 does not transmit an ACL data packet to the peripheral device in the following connection events, and the peripheral device does not transmit any ACL data packets to the central device. This can allow the peripheral device and/or the central device to save power by decreasing the amount of time over which the transceiver circuitry of either device is active, allowing hardware radio transceiver circuitry and/or one or more processors to be put into a lower-power mode. It may also allow a reduction in the occurrence of transmission scheduling collisions in the central device 102; for example, as shown in FIG. 3, where an ACL connection event 324 and a CIS connection event 346 happen to coincide, there is no clash of scheduling since the ACL connection 320 is suspended. The longer that the ACL connection 320 is kept in a suspended state, the more the possibility of clashing transmissions between the ACL connection 320 and the CIS connection 340 is reduced, thereby potentially increasing data throughput over the CIS connection 340. Suspending the ACL connection 320 may also beneficially reduce radio spectrum usage and/or free up time for the radios of the devices to be used for other purposes.

Once communication through the ACL connection 320 is suspended, the peripheral and central device may indefinitely suspend transmission and reception of data packets over the ACL connection. This suspension may be indefinite, until an indication is provided that the ACL connection 320 is needed for the transfer of data—i.e. an ACL activation request. In some embodiments, this request can be sent from the peripheral device 104-110 to the central device 102 to indicate that the peripheral device has data it needs to send to the central device through the ACL connection 320, while in other embodiments it can be sent from the central device 102 to the peripheral device 104-110 to indicate that the central device has data it needs to send to the peripheral device through the ACL connection 320. Some embodiments may support an activation request being sent in either direction.

For example, in FIG. 3, the second CIS data packet 360 shown which is sent from the central device to the peripheral device could comprise an ACL activation request in the form of a flag in the header portion of the CIS data packet 360 (i.e. a binary value having a predetermined value, such as a “one” bit, to signal the request).

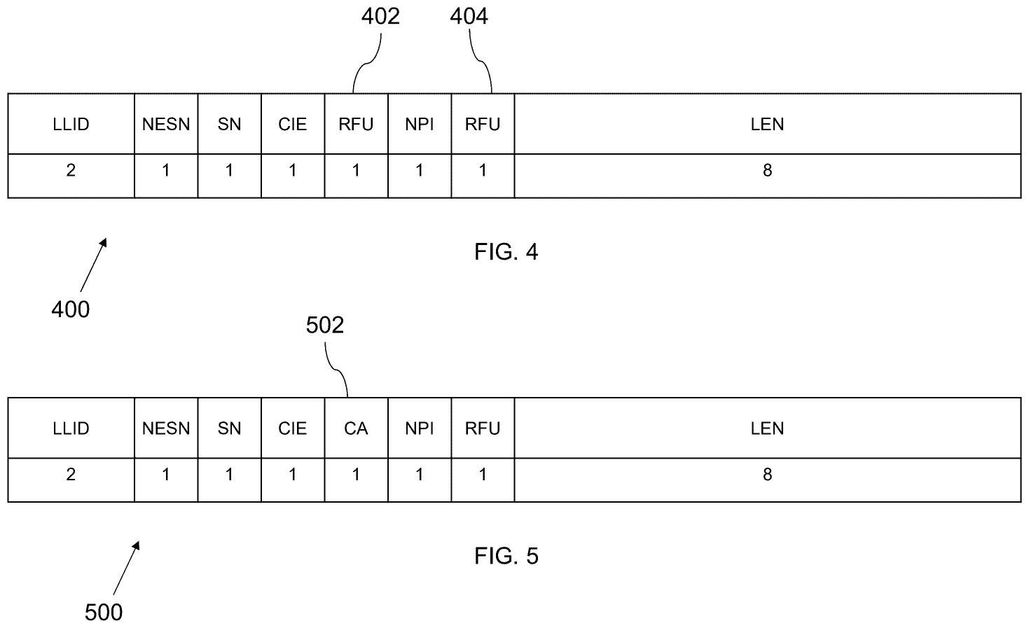

FIG. 4 is a schematic diagram of fields within the header portion of a conventional Bluetooth™ Low Energy Connected Isochronous Steam (CIS) protocol data unit (PDU). The header portion 400 comprises various control fields including a two-bit Logical Link identifier (LLID); a Next-Expected Sequence Number (NESN); Sequence Number (SN); Close Isochronous Event (CIE); Null PDU Indicator (NPI); and eight-bit length parameter (LEN) which specifies the length of the payload which follows the header. The header portion 400 also comprises two bits reserved for future use (RFU) 402 and 404. The payload of the CIS PDU 360 which follows the header portion may comprise audio data which is output by an audio codec at the central device such as the Low Complexity Communications codec used by Bluetooth™ LE Audio.

FIG. 5 is a schematic diagram of the fields within a header portion of a modified Bluetooth™ Low Energy Connected Isochronous Stream PDU that may be communicated by radio devices embodying the disclosure. The header portion 500 comprises the same fields as the header portion 400 shown in FIG. 4, expect that it has a connection activation (CA) field 502 in place of one of the RFU bits 402 shown in FIG. 4.

The connection activation field 502 may a flag to request the ACL connection 320 should be activated. For example, when the connection activation bit is set to “1”, the receiving device (e.g. the peripheral device) may be configured to switch on radio receiver circuitry for an ACL connection event which follows the receipt of a CIS data packet 360 in which the connection activation flag was set. In some examples, the receiving device (e.g. the peripheral device) switches on the radio receiver circuitry at the next ACL connection event 326 immediately following the receipt of a CIS data packet 360 in which the connection activation flag is set. The central device 102 then sends an ACL data packet 356 in this ACL connection event 326, which is received by the peripheral device 104-110. This can enable very low latency over the ACL connection 320 by using the CIS 340 to activate the ACL connection 320 much faster than might otherwise be possible, and with synchronisation already established.

In some embodiments the devices 102-110 may be configured to suspend an ACL connection 320 as soon as a CIS connection 340 has been established over it. However, in some embodiments suspension need not be automatic and instead the connection activation field 502 may be used as a flag to indicate that the ACL connection 320 should be suspended—e.g. by setting the connection activation bit to “0”. This may be referred to as an ACL suspension request. When such an ACL suspension request is received, the receiving device (e.g. the peripheral device) may be configured to switch off at least a portion of its radio receiver circuitry, e.g. before the next ACL connection event which follows the receipt of the CIS data packet containing the suspension request.

An ACL activation request and/or suspension request may be sent from the central device to the peripheral device (e.g. in the CIS data packet 360 and CIS data packet 364 respectively), or may be sent from the peripheral device to the central device—e.g. in CIS data packet 362 and CIS data packet 366 respectively. In some embodiments, an ACL suspension request could be sent over the ACL connection 320 rather than the CIS connection 340.

In some embodiments, where a suspension request is sent over a CIS, to indicate that the corresponding ACL should be suspended, the ACL connection may remain active indefinitely, even after the establishment of the CIS, until such a request is received. In other embodiments, the ACL connection may remain active for a predetermined period of time after establishing the CIS and/or after transmission of an ACL activation request. This could be implemented by a predetermined number of further connection events which the ACL connection should remain active for, e.g. a number of further connection events which is stored in the peripheral device and/or the receiving device. Alternatively, the number of ACL connection events to remain active for could be determined by data derived from the activation request—i.e. the data packet comprising the ACL activation request (e.g. the CIS data packet 360) may specify the number of connection events, or the length of time, for which the ACL radio connection should remain active before being switched back into a suspended state.

Any or all of the link layer control packet 350, acknowledgment packet 352 and connection establishment packet 354 could contain an indication that the CIS connection 340 and ACL connection 320 should operate according to a protocol supporting ACL suspension as described herein. Alternatively, this protocol may be set as the default behaviour for every ACL connection 320 and CIS connection 340 between the central and peripheral devices of the radio system 100.

The ability to suspend and reactivate the ACL may be especially useful in a scenario where most of the information being transferred between two devices is an audio stream over the CIS connection 340, and communication (e.g. to send or respond to a command, or to indicate an event) may need to occur only occasionally, over the ACL connection 320. For example, audio data may be being transferred via the CIS connection 340 from a central device such as a cell phone to a peripheral device such as an earphone at regular intervals, and a user may request a change in the volume of the audio by pressing a button on the cell phone. This request should be transferred to the earphone via the ACL connection 320. In this instance, following the button press, the activation flag in the header of the next packet 360 scheduled to be transmitted to the peripheral device over the CIS connection 340 may be set to indicate that the ACL connection 320 should be activated. Once the data packet 360 is received by the peripheral device, the peripheral device activates its radio transceiver for communication over the ACL connection 320 at the next connection event 326—i.e. to receive and thereafter acknowledge the next ACL packet 356 from the central device.

The disclosure is not limited to these embodiments and many variations and modifications are possible, within the spirit and scope of the disclosure.

We claim:

1. A first radio transceiver device, configured for communication with a second radio transceiver device, wherein the first radio transceiver device is configured to:
send to the second radio transceiver device, over a first radio connection between the first radio transceiver device and the second radio transceiver device, a connection establishment data packet comprising connection timing information for establishing a second radio connection between the first radio transceiver device and the second radio transceiver device; and
establish the second radio connection between the first radio transceiver device and the second radio transceiver device using the connection timing information,
wherein the first radio connection is associated with a first time series of periodic connection events for radio transmissions between the first radio transceiver device and the second radio transceiver device, and the second radio connection is associated with a second time series of periodic connection events for radio transmissions between the first radio transceiver device and the second radio transceiver device; and
wherein the first radio transceiver device is further configured, after the second radio connection has been established:
to suspend the first radio connection by ceasing transmitting any data packets to the second radio transceiver device over the first radio connection;
when the first radio connection is suspended, to transmit to the second radio transceiver device, or to receive from the second radio transceiver device, over the second radio connection, a data packet comprising an activation request; and
after transmitting the activation request, or in response to receiving the activation request, to activate the first radio connection by transmitting a data packet to the second radio transceiver device over the first radio connection in a connection event associated with the first radio connection.

2. The first radio transceiver device of claim 1, wherein the timing information transmitted to the second radio transceiver device in the connection establishment data packet comprises one or more connection parameters for the second radio connection.

3. The first radio transceiver device of claim 2, wherein the connection parameters comprise a connection interval length between each connection event in the second time series of periodic connection events.

4. The first radio transceiver device of claim 1, wherein the first radio transceiver device is configured to suspend the first radio connection in response to the second radio connection being established.

5. The first radio transceiver device of claim 4, wherein the first radio transceiver device is configured to suspend the first radio connection immediately after the second radio connection is established, by ceasing transmitting any data packets over the first radio connection from the next connection event of the first time series after sending the connection establishment data packet to the first radio transceiver device.

6. The first radio transceiver device of claim 1, wherein the activation request comprises a predetermined value at a predetermined position within the data packet comprising the activation request.

7. The first radio transceiver device of claim 1, wherein the first radio transceiver device is configured to activate communication through the first radio connection at the next connection event of the first time series following the transmission of, or following the reception of, the data packet comprising the activation request.

8. The first radio transceiver device of claim 1, wherein the first radio transceiver device is configured, after communication over the first radio connection has been activated by transmitting a data packet to the second radio transceiver in a connection event associated with the first radio connection, to maintain the first radio connection in an active state for at least one or more further connection events of the first time series.

9. The first radio transceiver device of claim 1, wherein the first radio transceiver device is configured, after the second radio connection has been established:
to receive from the second radio transceiver device, or transmit to the second radio transceiver device, a data packet comprising a suspension request; and
after transmitting or in response to receiving the suspension request, to suspend the first radio connection by ceasing transmitting any data packets to the second radio transceiver device over the first radio connection.

10. The first radio transceiver device of claim 1, wherein the first radio transceiver device is configured to use the second time series of periodic connection events to maintain synchronisation with the second radio transceiver device when the first connection is suspended.

11. The first radio transceiver device of claim 1, wherein the first radio transceiver device is configured to send and/or receive non-time-bound data to or from the second radio transceiver device over the first radio connection, and to send and/or receive time-bound data to or from the second radio transceiver device over the second radio connection.

12. The first radio transceiver device of claim 1, wherein the first radio transceiver device is a Bluetooth™ Low Energy device and each of the first radio connection and second radio connection is a respective Bluetooth™ Low Energy connection.

13. The first radio transceiver device of claim 1, wherein the first radio connection is an asynchronous connection-oriented logical (ACL) transport.

14. The first radio transceiver device of claim 1, wherein the second radio connection is a Bluetooth™ LE Audio connection.

15. A second radio transceiver device, configured for communication with a first radio transceiver device, wherein the second radio transceiver device is configured to:
receive from the first radio transceiver device, over a first radio connection between the first radio transceiver device and the second radio transceiver device, a connection establishment data packet comprising connection timing information for establishing a second radio connection between the first radio transceiver device and the second radio transceiver device; and
establish the second radio connection between the first radio transceiver device and the second radio transceiver device using the connection timing information,
wherein the first radio connection is associated with a first time series of periodic connection events for radio transmissions between the first radio transceiver device and the second radio transceiver device, and the second radio connection is associated with a second time series of periodic connection events for radio transmissions between the first radio transceiver device and the second radio transceiver device; and
wherein the second radio transceiver device is further configured, after the second radio connection has been established:
to suspend the first radio connection by ceasing receiving any data packets from the first radio transceiver device over the first radio connection;
when the first radio connection is suspended, to receive from the first radio transceiver device, or to transmit to the first radio transceiver device, over the second radio connection, a data packet comprising an activation request; and
in response to receiving the activation request, or after transmitting the activation request, to activate the first radio connection by receiving a data packet from the first radio transceiver device in a connection event associated with the first radio connection.

16. The second radio transceiver device of claim 15, wherein the second radio transceiver device is configured to support a low power state in which at least a portion of radio receiver circuitry of the second radio transceiver device is deactivated and/or a processor of the second radio transceiver device is in a sleep state, and is further configured, when the first radio connection is suspended, to enter the low power state at times within connection events of the first time series that are not within connection events of the second time series.

17. The second radio transceiver device of claim 15, wherein the second radio transceiver device is configured to send and/or receive non-time-bound data to or from the first radio transceiver device over the first radio connection, and to send and/or receive time-bound data to or from the first radio transceiver device over the second radio connection.

18. A method of communication between a first radio transceiver device and a second radio transceiver device, the method comprising:
transmitting, by the first radio transceiver device, over a first radio connection between the first radio transceiver device and the second radio transceiver device, a connection establishment data packet comprising connection timing information for establishing a second radio connection between the first radio transceiver device and the second radio transceiver device;
receiving the connection establishment data packet at the second radio transceiver device; and
establishing the second radio connection between the first radio transceiver device and the second radio transceiver device using the connection timing information,
wherein the first radio connection is associated with a first time series of periodic connection events for radio transmissions between the first radio transceiver device and the second radio transceiver device, and the second radio connection is associated with a second time series of periodic connection events for radio transmissions between the first radio transceiver device and the second radio transceiver device; and
the method further comprising, after the second radio connection has been established:
suspending the first radio connection by:
ceasing transmitting, by the first radio transceiver device, any data packets to the second radio transceiver device over the first radio connection; and
ceasing receiving, by the second radio transceiver device, any data packets from the first radio transceiver device over the first radio connection;
when the first radio connection is suspended, transmitting, by the first radio transceiver device to the second radio transceiver device, or by the second radio transceiver device to the first radio transceiver device, over the second radio connection, a data packet comprising an activation request; and
after transmitting the activation indication or in response to receiving the activation indication, activating the first radio connection by transmitting, by the first radio transceiver device to the second radio transceiver device, a data packet in a connection event associated with the first radio connection.

19. The method of claim 18, wherein each of the first and second radio transceiver devices is a respective Bluetooth™ Low Energy device, and each of the first radio connection and second radio connection is a respective Bluetooth™ Low Energy connection.

20. The method of claim 19, wherein the first radio connection is an asynchronous connection-oriented logical (ACL) transport, and wherein the second radio connection is a Bluetooth™ LE Audio connection.
